(19) United States
(12) Patent Application Publication
(10) Pub. No.: US 2007/0091037 A1
(43) Pub. Date: Apr. 26, 2007

(54) Energy Efficient Compact Display For Mobile Device

(76) Inventor: Yee-Chun Lee, El Cerrito, CA (US)

Correspondence Address: Sanjeet K. Dutta;ORRICK, HERRINGTON & SUTCLIFFE LLP, Suite 1600, 4 Park Avenue, Irvine, CA, 92614-2558, US

(21) Appl. No.: 11/163,536

(22) Filed: Oct. 21, 2005

(51) Int. Cl. G09G 3/34

(52) U.S. Cl. 345/84

(57) ABSTRACT

Provided herein are methods and systems for providing an energy efficient display for mobile devices which has the means to locate and track the head movements of viewers and steer focused display light output torward the direction or directions of users without user intervention. The required optical elements for both emissive and non-emissive steered display light output are discussed, as are the elements for head tracking.

### BACKGROUND OF THE INVENTION

The present invention relates generally to the field of flat panel display technologies. More particularly, this invention relates to a new display technology for compact, mobile devices.

### GENERAL BACKGROUND OF THE INVENTION

Mobile devices increasingly feature bright, full color displays with a wide viewing angle for displaying text and multimedia content. In Korea and Japan, third generation mobile phones are used for viewing television and for video conferencing. Sony's latest mobile game machine, the PSP (Play Station Portable), can also be used to view high quality movies. One of the biggest complaints of mobile devices is that they tend to have an extremely short battery life. This is primarily due to the large power consumption that such graphic intensive tasks entail, together with the large viewing angle requirement. With the rapid proliferation of third generation cellular phones, and with no recent advancements to battery technology, the situation is not likely to improve.

One of the characteristics of these multimedia intensive mobile devices is that they invariably are designed for a very limited number of viewers, typically one. This is due to the small size of such displays which can only be viewed up close. For such handheld displays, the viewing angle needs to be as wide as possible to allow them to be viewed regardless of viewer head or hand movement. Existing display technologies either have intrinsically large viewing angles, or relatively narrow viewing angles which have to be augmented by other techniques. OLED, for example, has a relatively wide viewing angle owing to its self-luminous nature. This self-luminous nature dispenses with backlighting, diffusers, and other light-robbing and viewing angle constricting baggage required by non-emitting display technologies such as liquid crystal displays. In contrast, LCD technology has a relatively small viewing angle owing to the need to use polarizers and the fact that the twisted light guide formed by the nematic liquid crystal director molecules is less capable of rotating obliquely propagating backlights than normal propagating ones. The addition of diffusers and the use of sub-pixels with different states of rotation can increase viewing angle sufficiently for mobile viewing at the expense of reducing brightness and image sharpness.

For one or two person viewing, the wide viewing angle created by the aforementioned technologies wastes battery power by sending light to directions away from the viewer's eyes. This is especially true when only one person is viewing the display, where easily more than 99% of the emitted light is wasted. Improvement of the power consumption can be achieved by focusing the emitted lights only towards the head of the viewer. Since well over 50% of the power consumption of a typical multimedia handheld device comes from that used to power the display screen, the use of projected lights can produce significant energy savings.

A potentially significant way to reduce display power consumption is to eliminate the need of backlight or light emitting elements. Although reflective LCD screens have found a use in older cell phones and other mobile devices which display mostly text information instead of graphics or videos, the reflective technologies do not produce sufficient contrast or colors that are vibrant enough to enable them to be used for graphic intensive applications without significant power drain.

A new reflective technology, invented by Iridgm, is based on the concept of interference modulation and uses micro electromachanical system, or MEMS, technology for actuation of the micro-modulators. Multiple display elements are grouped together to form a pixel, or picture element. For example, to generate a 36 color display, 36 Iridgm elements are used. Each Iridgm element can be either turned on or off depending on the voltage applied, which switches the metallic membrane to one of its two stable states.

Although Iridgm technology has much higher reflectivity and does not suffer from contrast inversion associated with the polarization-based reflective display technologies that precede it, the difficulty in making high color resolution displays and the need to use a large number of display elements to form a single pixel ultimately relegates it to the low end niche market for mobile displays.

Additional advancements in LCD technologies include MVA (multi-domain vertical alignment) from Fujitsu, IPS (in-plane switching) from Hitachi, ASV (Axial symmetric view, or Advanced super view) from Sharp and PVA (patterned vertical alignment) from Samsung.

LCDs with MVA technology have the advantages of a wide viewing angle, brighter display and higher color uniformity over standard LCDs. These benefits are achieved by aligning the liquid crystals in multiple directions in a single cell. Protrusions on the glass surface pre-tilt the molecules into the appropriate direction. The combination of molecules oriented in multiple directions and a small area allows for the brightness of the cells to appear uniform over a multitude of viewing angles.

IPS LCDs have wide viewing angles and good contrast ratio. IPS sets pairs of electrodes on the sides of each cell with a horizontal electric field through the liquid crystals. The liquid crystals are then set parallel to the front of the display for a wide viewing angle. When the electric field is applied, the molecules turn on their axes to align with the field. This differs from traditional LCDs in that the liquid crystals, while still cigar shaped, no longer twist and tilt. Elimination of the twisting and tilting clears the optical path. The result is a display that stays bright and clear over a wide range of viewing angles.

ASV LCDs use a specially designed cell structure to achieve quick response times, up to twice as fast when compared to traditional LCDs. The upper electrode is made very small, and when the electric field is applied, the molecules create an umbrella-shaped alignment in each subpixel. This technology also has the ability to display 10 bits of data per red, blue, and green sub-pixel. The benefits of this technology, aside from the quick response time, are wide viewing angles and high contrast.

PVA technology is similar to MVA. Like MVA, PVA uses pairs of electrodes on the sides of each cell with an electric field through the material. The top and bottom electrodes are offset, forcing the liquid-crystal molecules to align differently within each subpixel. The application of the electrical field shifts the liquid crystals to produce the image. PVA technology results in wide viewing angles.

All of the aforementioned LCD technologies, especially IPS, are unsuitable for battery powered applications due to increased power consumption.

An object of the present invention is to provide an enhancement to existing emissive compact display technologies which can reduce the energy consumption of the light emission portion of the display by an order of magnitude.

Another object of the present invention is to provide such enhancement without substantially increasing the manufacturing cost, and without reducing the user's viewing comfort of such devices.

Yet another object of the present invention is to provide a graded energy saving for the mobile display that yields the greatest energy saving when there is only a single viewer for the device and progressively lower energy savings for two or more viewers.

Still another object of the present invention is to provide a compact mobile display that would automatically turn off when no viewer is within range.

A still further object of the present invention is to provide a compact mobile display that supports a private viewing feature so that only the person who is most nearly directly in front of the display screen can view the content of the display clearly, while others should only see dark or dim, blurry screen.

### SUMMARY OF THE INVENTION

To achieve these and other objects there is provided a system and method for an improved compact display for mobile devices which has the means to detect and track the head movements of viewers and steer focused display light output toward the direction or directions of users without user intervention. The system also has the means to focus both emissive and non-emissive display light output using an innovative micro-lens array alone or in combination with a viewing angle constricting focal plane micro-mirror array.

The micro-lens array, in accordance with the present invention, comprises of a two dimensional array of microscopic lenses each of which is substantially the same size as a pixel and is designed to collimate the light emitted from the corresponding pixel that it covers. The pixels lie on the focal plane of the micro-lenses so as to optimize collimation efficacy. The collimated light projected from the screen will result in an increased light intensity in proportion to the degree of collimation. The energy saving comes from the reduction of the total light output in order to match the intensity of the unfocused display device.

The tracking of the head movements of viewers is performed by a two stage process. In the first stage images projected onto two imaging arrays are used to compute autocorrelation functions. An estimation of the possible head location or locations can be obtained from the computed correlation functions. The estimated head locations are then used as a starting point of an iterative procedure to more precisely determine the head locations from a low resolution 2-D pinhole camera based on the preliminary estimates of the head location data obtained from the correlation computation of the linear array data.

Based on the head location information, the micro-lens array is shifted accordingly to steer the narrowly focused light beam emitted from the display screen to point it toward the head or heads. The movement of the micro-lens array is provided by micro-actuator means, which could be based on piezoelectric materials, or electret polymers, or by shape memory alloy. For slightly large size compact displays, voice coil actuators can also be used to provide the larger displacements that are needed for those displays.

Alternatively, the beam steering can be done electronically by subdividing the pixels into a plurality of sub-pixels and by switching from among the sub-pixels. The sub-pixel switching method can steer the beam to aim at the directions of more than one viewer. With more than one viewer, the sub-pixel switching method also consumes less power since it takes no additional energy to switch among multiple viewing angles. Mechanical steering means, on the other hand, consumes far more energy moving the micro-lens array back and forth.

Another alternative way, relevant to the LCD displays, of reducing beam divergence or viewing angle of the display is to remove or disable all viewing angle enhancement filters and to avoid using sub-pixels. Without any viewing angle enhancement, the intrinsic beam divergence of the LCD display is relatively small. The unenhanced LCD screen costs less, and energy saving comes from the reduction of the brightness of the backlight. Beam divergence of LCD backlights can be preserved through use of a collimated backlight, resulting in the highest possible contrast ratio

Additional reduction of the beam divergence may be accomplished with a micro-mirror array placed directly on top of the pixels. The mirror array comprises a plurality of micro-mirrors, one for each pixel or subpixel. Each micro-mirror has the identical shape of an axisymmetric hour glass, with the inner mirror wall gently narrows from one opening of the mirror to the mid-plane constriction minimum, and then widens gently again to the other opening.

Subpixel beam steering and collimating method requires new addressing schemes that minimize addressing overhead that is needed to drive the large number of sub pixels. In accordance with one embodiment of the present invention, there is provided a subpixel addressing method that employs separated subpixel row and column drivers in addition to the conventional X-Y pixel addressing drivers.

An alternative embodiment of the subpixel switching concept is to employ a single separate subpixel selection driver that is common to all pixels in the display. This increases the number of addressing lines per pixel by the number of sub pixels in each pixel, in addition to the conventional X-Y pixel addressing lines.

Another aspect of the present invention is a process for the display device that employs the innovative subpixel addressing method to adapt to a changing viewing environment in real time according to the following steps:

providing a tracking algorithm and device that can track simultaneously a plurality of viewer head movements and estimate the locations of all the heads in real time;

determining which subpixel or subpixels to turn on by mapping viewer head locations to subpixel addresses;

turning on those sub rows and sub columns that contain these subpixel addresses; if the subpixel addressing is done with a direct subpixel selection process rather than with a sub column and sub row addressing process, then only the subpixel addresses that match the head locations are selected.

For LCD displays, multi-viewer adaptation is accomplished by scanning the micro-lens array rapidly in time to cover multiple viewing angles and by adjusting the brightness of the backlight to compensate for the lost in light intensity for any particular viewer.

Still another aspect of the present invention is an adaptation process for compensating for the level of estimation uncertainty by alternatively narrowing or broadening the effective viewing angles. This ensures that the viewer or viewers will have full views of the screen even when there are fast head movements or external interferences that reduce head location estimation accuracy.

Yet another aspect of the present invention is a method and device for enhancing the privacy of the viewer by either tracking only heads that are within a user defined distance for the display screen or by limiting only a very small number of viewers to access the screen, the maximum number of viewers being user definable.

Thus in accordance with the present invention, there is provided a device and procedure for reducing the power consumption of the illumination portion of a compact display by adaptively narrowing the true viewing angle of the display and by head tracking to keeping the display screen to be within sight of the viewer or viewers. The reduction of the true viewing angle of the compact display while maintaining a wide effective viewing angle simultaneously increases display quality and decreases power consumption and extends battery life.

### BRIEF DESCRIPTION OF THE DRAWINGS

Various other objects, features and attendant advantages of the present invention will become fully appreciated as the same becomes better understood when considered in conjunction with the accompanying drawing, in which like reference characters designate the same or similar parts throughout the several views, and wherein:

FIG. 1 is a schematic view of an embodiment of the steered beam microlens display employing a mechanically steered microlens array suspended over an OLED pixel array.

FIG. 2 is a schematic view of another embodiment of the steered beam microlens display using a fine resolution subpixel OLED array and active matrix subpixel beam switching with a fixed microlens array suspended over the OLED array.

FIG. 3 is a schematic view of still another embodiment of the steered beam microlens display using a micro-mirror collimated LCD array with a mechanically steered microlens array suspended over the OLED array.

FIG. 4 is a diagrammatic view illustrating how beam steering and reduction of beam divergence can reduce power consumption while maintaining usable viewing angle.

FIG. 5 is another diagrammatic view illustrating the steering of the beam when the viewer looks directly at the screen.

FIG. 6 is yet another diagrammatic view illustrating the steering of the beam when the viewer looks at the screen at an oblique angle.

FIG. 7 illustrates one embodiment of the mechanical steering of the microlens array using two pairs of piezoelectric copolymer bimorph actuators.

FIG. 8 is a schematic of one of the preferred embodiments of the piezoelectric bimorph actuator using an analog-to-digital converter.

FIG. 9 is a more detailed schematic view of the bimorph driver for the embodiment depicted in FIG. 8.

FIG. 10 is a schematic of yet another preferred embodiment of the piezoelectric bimorph actuator using a pulse coded modulation controller.

FIG. 11 is a more detailed schematic view of the bimorph driver for the embodiment depicted in FIG. 10.

FIG. 12 illustrates the beaming forming characteristics of an OLED subpixel with an aperture that is substantially smaller than the aperture of the microlens.

FIG. 13 shows the beam tilting of an OLED subpixel array when the subpixel of every pixel at the same relative location is turned on so as to project beams pointing in the same direction.

FIG. 14 is a detailed view of a normal projection of a collimated beam from an OLED subpixel located on the focal plane of the microlens with its center in coincidence with the axis of the microlens.

FIG. 15 shows an obliquely projected beam from an OLED subpixel located on the focal plane of and off axis from the microlens.

FIG. 16 illustrates the improvement of the light collection efficiency of the microlens with its focal length while keeping its aperture fixed.

FIG. 17 shows an embodiment of the micro-mirror collimator which converts a widely diverging light emission into a well collimated beam.

FIG. 18 shows the interplay between the micro-mirror array and the microlens array that together can reduce both beam divergence and provides beam tilting.

FIG. 19 illustrates an embodiment of the subpixel active matrix addressing using a separate common sub-column and sub-row selection drivers along with conventional row and column drivers.

FIG. 20 shows an embodiment of the subpixel addressing electronics for a 3 by 3 subpixel configuration requiring only two additional transistors per pixel over those required by a conventional X-Y matrix addressing scheme.

FIG. 21 illustrates an embodiment of the subpixel active matrix addressing using a single separate common subpixel selection driver along with conventional row and column drivers.

FIG. 22 shows an embodiment of the subpixel addressing electronics for a 9 subpixel configuration requiring no additional transistor over those required by a conventional X-Y matrix addressing scheme but needing 9 additional subpixel selection addressing lines.

FIG. 23 shows an embodiment of the subpixel addressing electronics for a voltage based pixel activation display with a 9 subpixel configuration that requires a reverse blocking diode for each subpixel to prevent subpixel crosstalk through the global connection of each subpixel.

FIG. 24 shows the image formation of the viewer's head by a linear CMOS array with two pinholes.

FIG. 25 is a flow chart for the estimation of the head and eye location information.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well-known methods, procedures, materials, components and circuitry have not been described in detail to avoid unnecessary obscuring aspects of the present invention. The detailed description is presented largely in terms of simplified two dimensional views. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of process flow representing one or more embodiments of the invention do not inherently indicate any particular order nor imply any limitations of the invention.

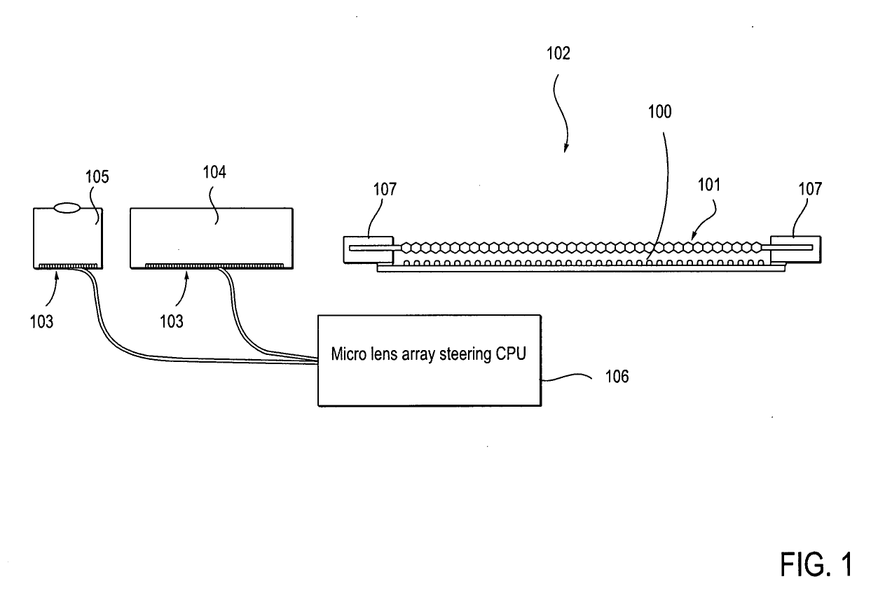

Turning now to the drawings, FIG. 1 is a schematic view of an embodiment of the steered beam microlens display system employing a mechanically steered microlens array suspended over an OLED pixel array. The system comprises a tracking subsystem, and a beam steering subsystem. The tracking subsystem includes a plurality of linear CMOS array dual pinhole imagers, a low resolution CCD camera, and a dedicated or shared CPU (central processing unit) to convert the imaging input into beam steering control output. The beam steering subsystem comprises a microlens array suspended over a modified or unmodified OLED display so that the OLED array is on the focal plane of the microlens array, and a plurality of digitally controlled actuators which serve to displace the microlens array in the X, or row-wise, direction, as well as in the Y, or column-wise direction.

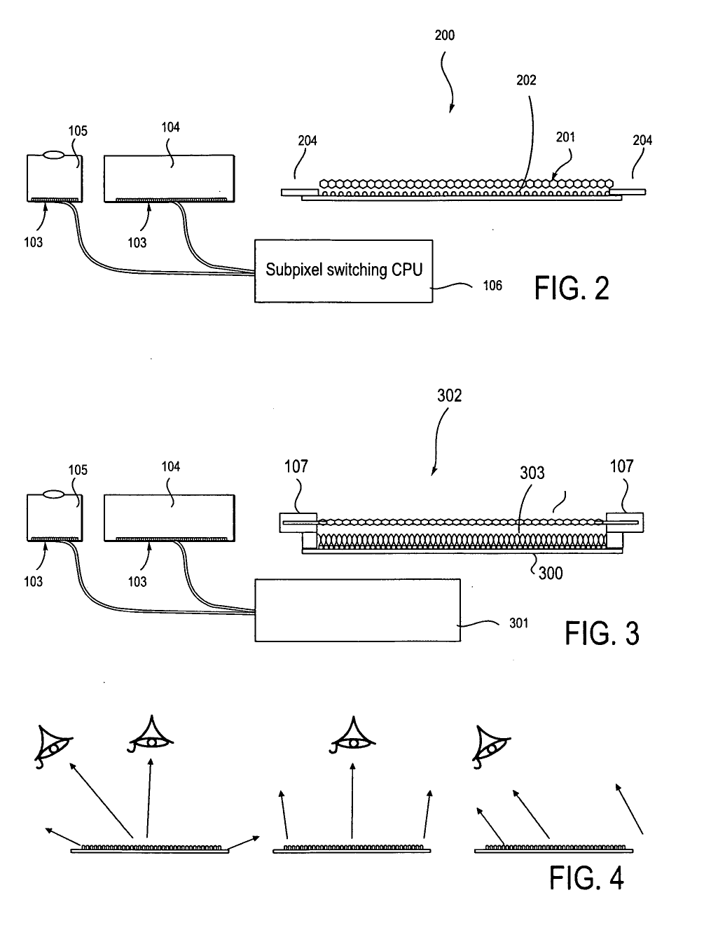

FIG. 2 is a schematic view of an embodiment of the steered beam microlens display system employing a fixed microlens array suspended over an OLED subpixel array. The system comprises a tracking subsystem, and a beam steering subsystem. The tracking subsystem includes a plurality of linear CMOS array dual pinhole imagers, a low resolution CCD camera, and a dedicated or shared CPU (central processing unit) to convert the imaging input into beam steering control output. The beam steering subsystem comprises a microlens array suspended over a modified or unmodified OLED display so that the OLED array is on the focal plane of the microlens array, and a plurality of subpixel selection drivers which serve to select a subset of the subpixels within each pixel to electronically alter the beam direction.

FIG. 3 is a schematic view of an embodiment of the steered beam microlens display system employing a mechanically steered microlens array suspended over a LCD pixel array. The system comprises a tracking subsystem, and a beam steering subsystem. The tracking subsystem includes a plurality of linear CMOS array dual pinhole imagers, a low resolution CCD camera, and a dedicated or shared CPU (central processing unit) to convert the imaging input into beam steering control output. The beam steering subsystem comprises a microlens array suspended over a micro-mirror collimated LCD display so that the aperture plane of the micro-mirror array coincides with the focal plane of the microlens array, and a plurality of digitally controlled actuators which serve to displace the microlens array in the X, or row-wise, direction, as well as in the Y, or column-wise direction.

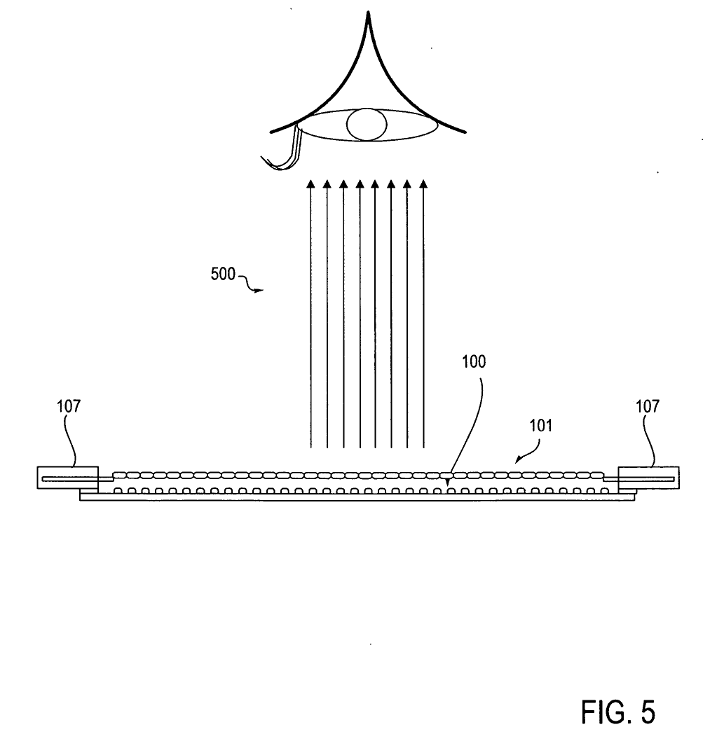

FIG. 4 is a diagrammatic view illustrating how beam steering and reduction of beam divergence can reduce power consumption while maintaining usable viewing angle. In a prior art wide viewing angle display, the beam emanating from each pixel has a large divergence, allowing the display to be easily viewed at different head locations or for simultaneous viewing by multiple viewers. Such ease of viewing comes at the price of heavy power consumption since the overwhelming majority of the light emitted by the display screen is wasted. With a steered beam system, a narrow beam is directed only at the head or eyes of the viewer, resulting in a dramatic power saving. As the viewer's head moves, so does the beam which tracks the head's movement, hence the effective viewing angle is broad even though the true viewing angle is small.

FIG. 5 is another diagrammatic view illustrating the steering of the beam when the viewer looks directly at the screen. As shown, the electromechanical X-Y drive actuators are in their rest, or nominal, positions to place each microlens directly on top of each OLED pixel in such a way that the beam projected by each pixel through the corresponding microlens is straight up into the viewer's eyes.

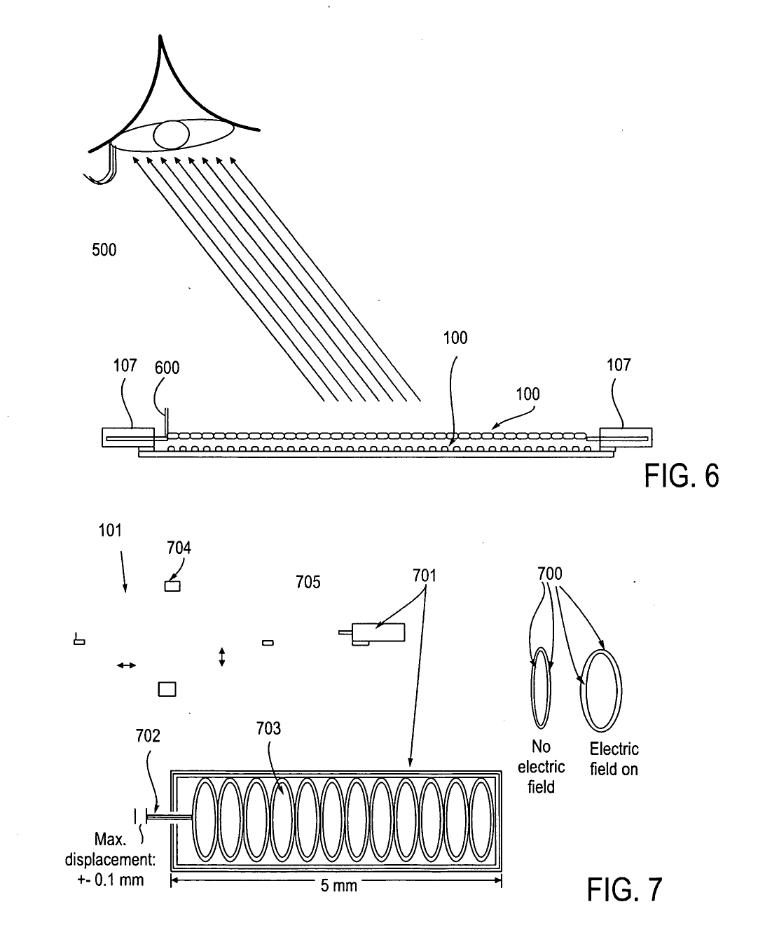

FIG. 6 is still another diagrammatic view illustrating the steering of the beam when the viewer looks at the screen at an oblique angle. As shown, the electromechanical X-Y drive actuators move the microlens array to place each microlens slightly to the left of the center each OLED pixel in such a way that the beam projected by each pixel through the corresponding microlens is directed into the viewer's eyes.

FIG. 7 illustrates one embodiment of the mechanical steering of the microlens array using two pairs of piezoelectric copolymer bimorph actuators. As shown, each X-Y drive comprises a multitude of piezoelectric bimorph actuating elements stacked together within an elongated enclosure with a closed end and an end with an aperture through which a push pin is inserted. The individual piezoelectric bimorph actuating element comprises two pre-bent piezoelectric bimorphs bonded together at both ends to form an ellipse. The width of the ellipse can be altered by applying a positive or negative voltage across the electrodes of the bimorphs. Since the piezoelectric bimorphs are essentially capacitors from an electrical perspective, the actuators would consume power only during changes in their position settings. Thus for a stationary viewer, even though a voltage is applied across the thickness of the piezoelectric thin film element, the only power consumption would be from the supporting circuitry.

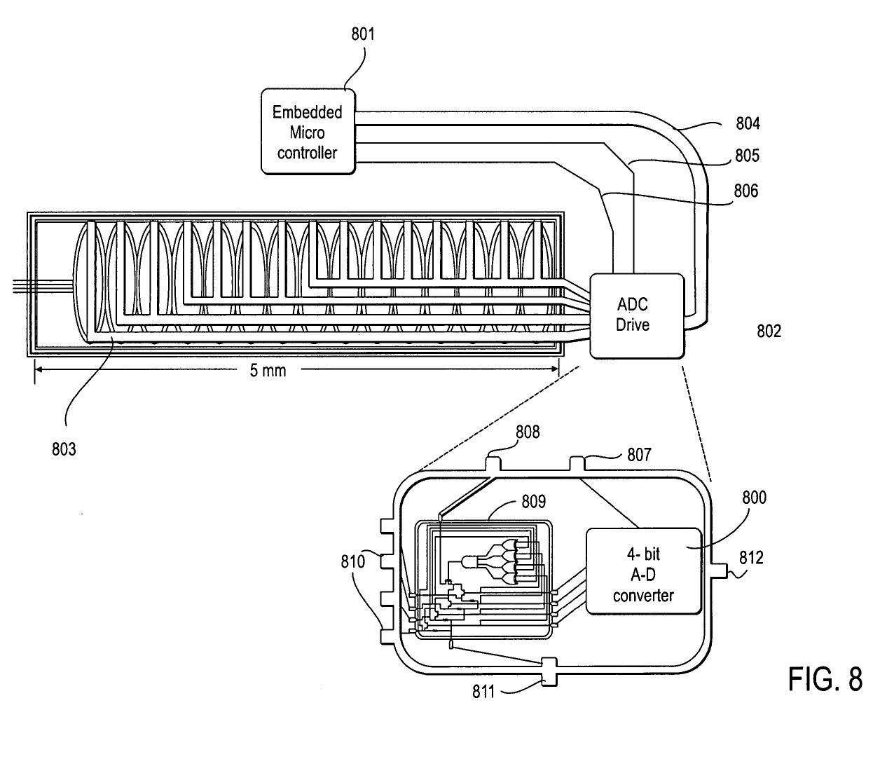

FIG. 8 illustrates a preferred embodiment of the bimorph actuator. A 4-bit analog-to-digital (A-to-D) converter converts the digital numerical input from the microcontroller to 4 parallel output voltages of HIGH and LOW. The HIGH voltage is typically the upper rail voltage that drives the A-D converter, or ADC, and the LOW is typically ground voltage. The most significant bit is used to drive the first eight bimorph actuating elements, and next significant bit the next four elements, the third significant bit the next two actuating elements, and the least significant bit the last actuating element. Thereby if both the most significant bit and the least significant bit are turned on, then the most significant bit produces 8 units of displacement, and the least significant bit one unit of displacement, for a total of nine units of displacement. And since 1001 corresponds to the numeral nine, it follows that, by extension, any 4-bit numeral issued by the microcontroller would actuate the piezoelectric X-Y drive actuator by like units of displacement. Thus each pair of X-Y drive can produce 16 different displacements, for a total of 16×16=256 possible X-Y positions for the microlens array. This provides sufficient resolution for beam steering purpose.

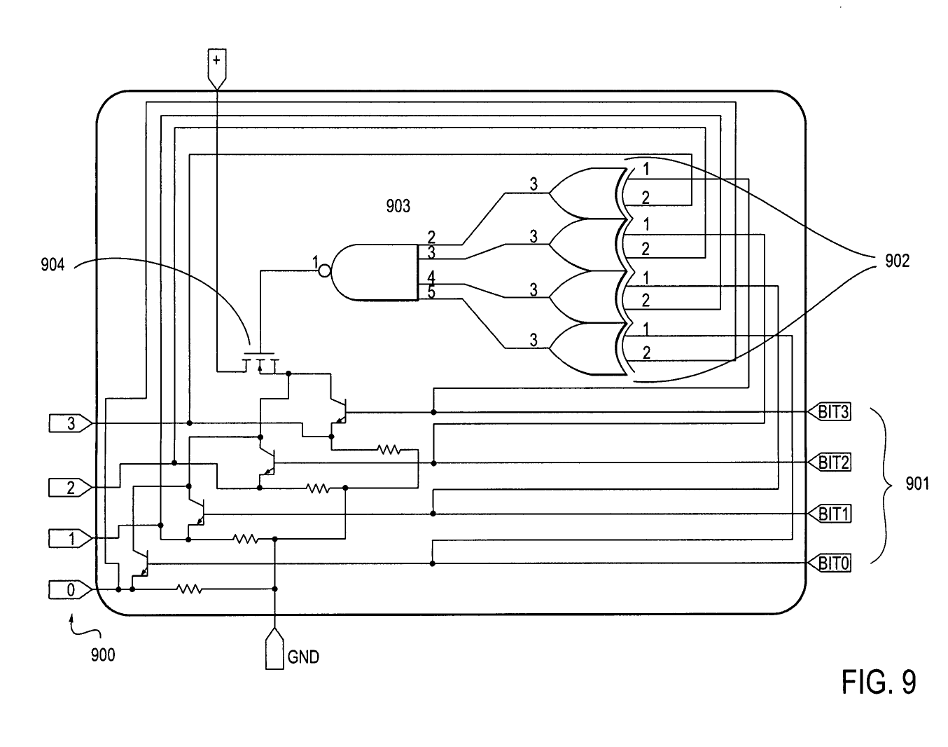

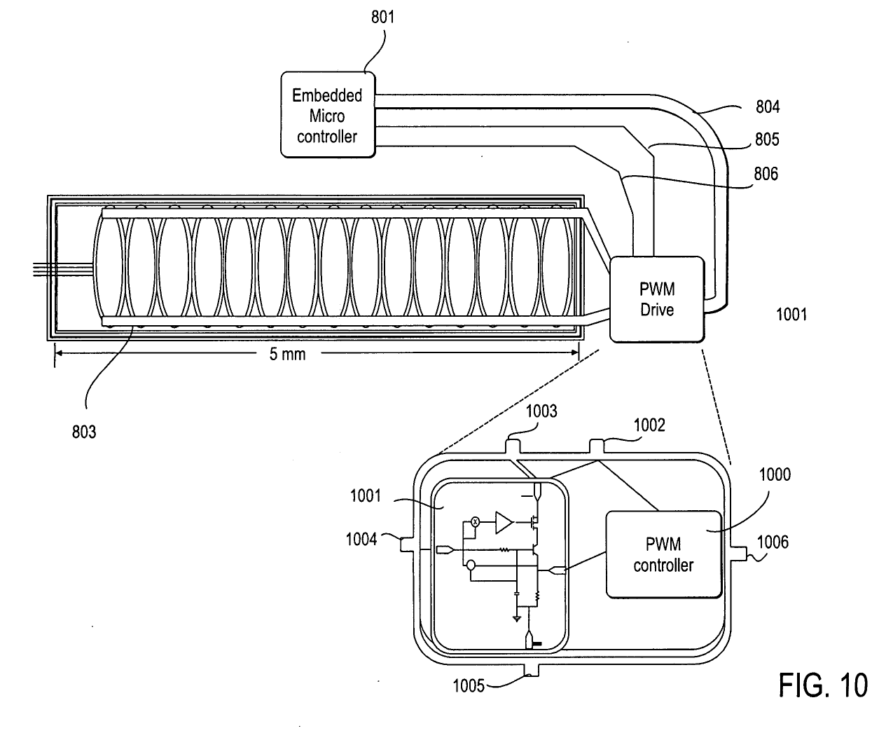

Reduction of power consumption is accomplished with a pass transistor gated by the output from the comparator logic. The detail is illustrated in FIG. 9, where the 4-bit output of the ADC, which can only source minute amount of current, are current amplified by four emitter followers. Since the emitter followers consume substantially constant power, they need to be shut off when there is no change of the ADC output bit values. This is accomplished with a comparator circuit which comprises four “exclusive or”, or “XOR” gates, and a four input NAND gate. The comparator logic performs the exclusive or operation on the input of the ADC and the bits stored in the piezoelectric bimorph elements which act like large storage capacitors. Any change in bit value between the input and the corresponding bimorph bit will produce a zero. The NAND gate output goes high if any of the XOR output is zero. The collectors of the NPN transistors that constitute the emitter followers are gated by the MOSFET pass transistor which in turn is gated by the output of the NAND gate. When there is no change in the ADC bit values, the NAND gate stays low, which turns off the emitter followers to conserve power. A change in the ADC output turns the emitter followers for one clock cycle to charge (or discharge) the piezoelectric bimorph elements. During the off periods of the pass transistors, the charges, and therefore voltages held by the bimorph elements would not change. The head movement is slow in typical viewing situations, which means the emitter followers are on infrequently and only for one clock cycle at a time. This dramatically cuts down on the power consumption that arises from the mechanical steering of the microlens array. Assuming a 10% mechanical efficiency of the piezoelectric actuation, and the overall electrical efficiency of 30% for the piezoelectric driver, at the maximum steering speed of 100 Hz, the actual mechanical power needed is about 30 mW, but the overall power consumption will be of the order of a watt because of the power conversion inefficiencies. It is thus followed that the power saving that can be realized using gated emitter followers will be significant for a small powered device whose total power consumption is in the range of a few watts.

An alternative preferred embodiment is shown in FIG. 10, where a PWM (pulse coded modulation) controller is used to convert a numerical value to a pulse coded modulation signal gated by the clock signal and latched by a PWM latch. All the piezoelectric bimorph actuating elements are driven simultaneously by the PWM bimorph driver with just a positive output and a ground. Unlike the embodiment depicted by FIG. 8, the piezoelectric drive voltage is analog, not digital. A bimorph driver is used to integrate the PWM signal as well as to amplify the meager currents sourced by the PWM controller. The bimorph driver is gated both by the clock signal and by the difference signal generated from the PWM input and the stored voltage value of the bimorph actuator to reduce power loss during power conversion and amplification.

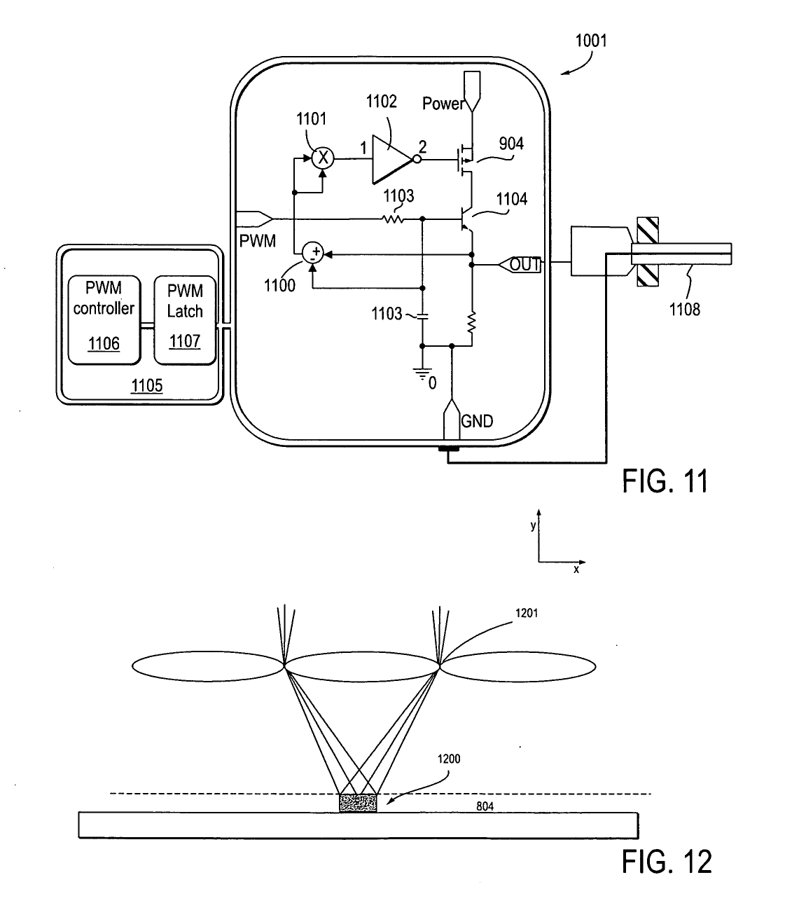

FIG. 11 is a more detailed schematic view of the bimorph driver. The low pass filter is a simple R-C (resistor-capacitor) circuit that converts the PWM signal into a smooth analog signal. The low pass filtered signal is used to drive a NPN transistor based emitter follower that is gated by a MOSFET pass transistor. A comparator network that comprises an analog comparator, a Gilbert cell multiplier, and an inverter compares the RC filtered PWM voltage with the voltage stored in the piezoelectric bimorph actuator. The Gilbert cell multiplier removes the sign of the difference so that only the magnitude of the difference matters. The inverter converts a HIGH signal into a LOW signal to turn on the PMOS pass transistor when the difference exceeds a certain threshold value to enable the emitter follower. Otherwise the emitter follower is off. Once the MOS pass transistor is turned on, it stays on only until the next clock signal arrives, then it is turned off. The clock line that turns off the MOS transistor is not shown in the figure for simplicity. Since the emitter follower is very inefficient in converting the RC filtered PWM signal into the output current required for driving the piezoelectric bimorph actuator, PWM based approach would normally require far more power to drive the microlens array at any speed. By switching the emitter follower off until the filtered PWM signal is greater or less than the piezoelectric voltage by at least a certain small amount, and by keeping the emitter follower on for a maximum of one clock cycle, the power efficiency of the piezoelectric bimorph driver improves drastically.

The actual reduction of the luminous power of the display device depends on how well the viewing angles, or beam divergence, can be reduced. The greater the reduction, the greater the power saving. Once the luminous power consumption drops to certain level, power consumptions from other supporting electronics will dominate, at that point any further reduction of the beam divergence can be advantageously employed to increase the apparent brightness of the screen without attendant increase in power consumption.

Focal plane focusing of the pixels by the microlens array is somewhat effective in reducing the beam divergence. However, its effectiveness ultimately rests on how far the focal length of the microlens can be shortened, what the filling ratio of the pixel array is, as well as on how close the microlens is in conforming to the lens maker's formula. Intrinsically narrow viewing angle displays such as LCD displays normally require view angle enhancement measures to make them acceptable for normal viewing; hence their viewing angles can be expeditiously decreased by removing those measures. Alternative means of viewing angle reduction thus will be needed in order to fully exploit the beam steering mechanisms described so far.

One alternative way of reducing the viewing angle is to make pixel size much smaller than that of the aperture of the micro-lens and place the light emitting pixel on the focal plane. The divergence of the beam is determined by the spatial spread of the pixel. For an ideal point pixel, the output beam after the lens is completely collimated (beam divergence is zero), at least for an ideal lens (one that satisfy lens maker's formula). For an ideal lens, any point light source on the focal plane creates a perfectly collimated beam with no beam divergence. For a finite light source on the focal plane, the beam divergence is directly proportional to its physical extend. Additional beam divergence (viewing angle divergence) comes from the non ideal nature of a physical lens. Pixel aperture reduction can be combined with aforementioned mechanical steering means to produce an energy saving broad viewing compact display device. It can also be used in a subpixel scheme that uses light emitting elements with subpixel aperture to collimate and steer without any additional mechanical means of beam steering. The viewing angle reduction achieved by subpixel aperture method will not realize any energy saving for a non-emissive display such as a LCD display. This is because the non emissive display technologies all rely on some sort of light valves to modulate the backlight that transmits through each pixel, hence the power consumption stays constant irrespective of what is the percentage of pixels that are turned on. Whatever fraction of backlight that is not transmitted is simply absorbed or reflected by the light valves. For emissive displays, such as OLED displays, the energy saving comes from the fact that only a small fraction of the pixel aperture is lit.

Micro-mirror array also enhances the light collection efficiency of the micro-lens array since it concentrates the beams emitting from the pixels or sub pixels before they reach the micro-lens array, effectively increasing the numerical aperture of the micro-lens array. Numerical aperture in Optics measures the ability of the optical device to bend more light into the lens, thereby enabling the lens to capture more emitted light from a light source.

Micro-mirror collimator only allows lights emitted from the OLED element that lie within a narrow cone to go out, those lights that are reflected back to the OLED element either get reflected again by the smooth face of the OLED element or get reabsorbed by OLED and retransmitted at a slightly later time. Those lights that are reflected back into the micro-mirror can either go out or not, determined again by the same light cone. The process can repeat ad infinitum until the lights have either escaped or absorbed. For a mirror with near unity reflection coefficient, the conversion from wide-angle beams to narrow angle beams is high.

An alternative way to increase the light collection efficiency is to have a very short focal length of the micro-lens array. A lens with a short focal length means that the angular aperture of the lens is large, and for a Lambertian light source such as an OLED pixel, this implies more light emitted from the source is collected by the lens. Increasing light collection efficiency improves the display quality by making the individual pixels brighter. It also enhances dynamic contrast ratio.

FIG. 12 illustrates the beaming forming characteristics of an OLED subpixel with an aperture that is substantially smaller than the aperture of the microlens. This method is advantageous only for emissive displays, for which the energy saving comes from the fact that for one or two viewers, only one or two sub-pixels of every pixel needs to be lit up at any given time. Thus, for example, if each pixel consists of 36 sub-pixels, and if there is only one viewer, then only one out of every 36 sub-pixel is lit, resulting in a saving of 35/36. In order to realize such saving for compact displays, the emissive display technology must be able to support the high resolution that is required of these sub-pixels. OLED is one such technology which satisfies the high resolution requirement. The light emitting elements of OLED can be smaller than 20 micron, which makes it possible to build a high 320×240 resolution, 1.6 in×1.2 in OLED display screen with 6×6 sub-pixels per pixel. Even higher resolution can be expected in the future as OLED technology matures.

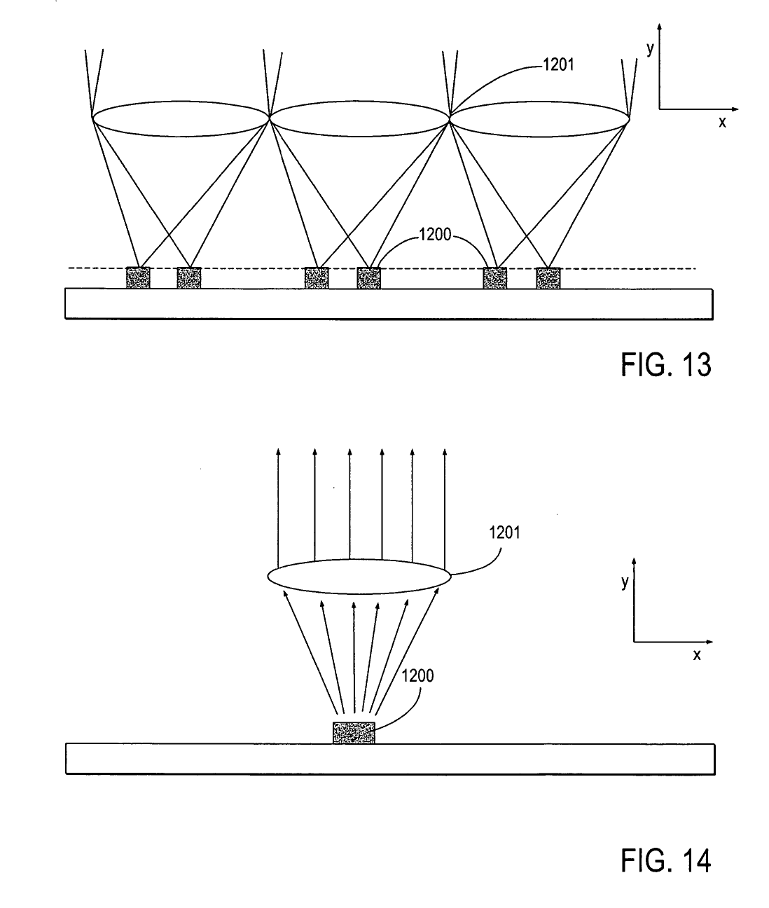

FIG. 13 shows how subpixel beam-steering works. By aligning the microlens array such that every subpixel in the display that is in the same relative position within the corresponding pixel would project collimated beam along the same direction, beam steering, or tilting, can be accomplished by switching from one subpixel to another for all the pixels in the display.

FIG. 14 provides a schematic ray tracing view of a subpixel aperture whose horizontal coordinates coincide with those of the center of the microlens aperture. Since the light emitting surface is on the focal plane of the microlens, the microlens collimates the light emitted from the OLED pixel substantially in the normal direction. The native viewing angles of the subpixel can be made small by shrinking the subpixel aperture. Both the fact that the OLED pixel has a finite physical extent and the fact that the optical characteristic of a physical lens differs from that of the ideal lens prevents the output beam divergence from being arbitrarily small. A further issue with a small beam divergence is that both the tracking accuracy and the tracking latency requirements increase with decreasing beam divergence. A native viewing angle of 30 to 60 degrees will lessen the beam steering requirement since perfect tracking is not necessary.

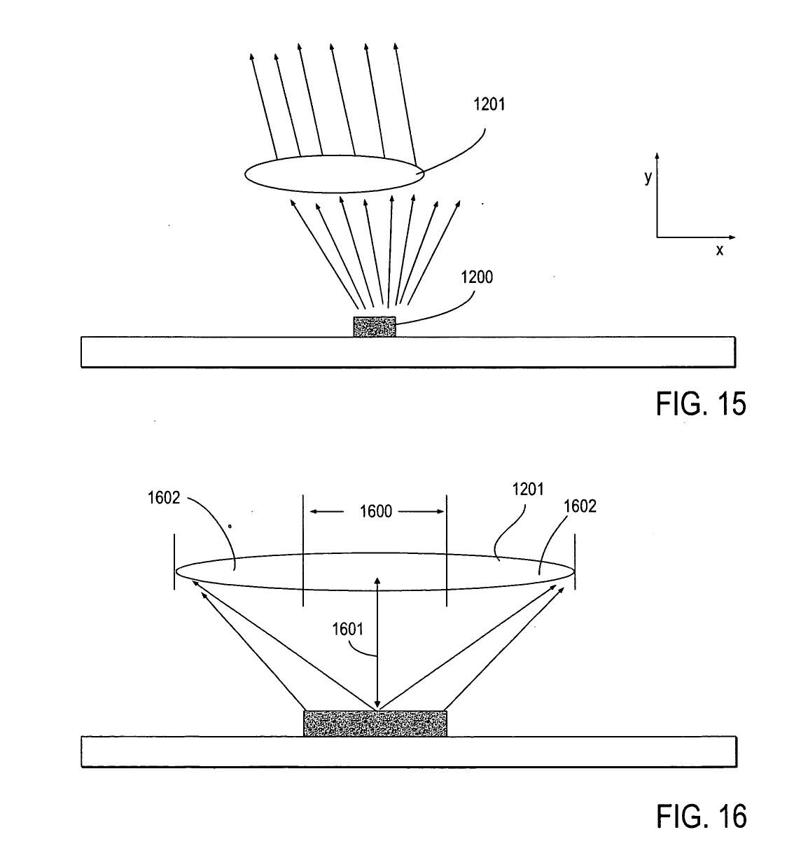

FIG. 15 is yet another schematic ray tracing view of a subpixel whose horizontal coordinates are to the right of the center subpixel. The output beam now points at an angle that is primarily determined by the angle the line that passes through both the center of the pixel and the center of the lens makes. As shown in this figure, some of the light that emanates from the OLED no longer reaches the lens, so there is also some loss of output light intensity.

FIG. 16 shows that to have high light collection efficiency, the micro lens should have a very small focal length. Ideally, the focal length should be smaller than the radius of the lens itself. For such a short focal length, the “lens maker's formula” is only valid in a small circular region called the “linear region”. For radius beyond that, the lens maker's formula only approximately applies, with deviation which increases as the radius increases. The relatively short focal length of the lens allows the lens to capture almost all lights that emanate from the OLED. For typical cell phone displays, the focal length of the micro lens should be about 0.1 mm, or 4 mils. The micro lens array should have a maximum shift of +−0.1 mm.

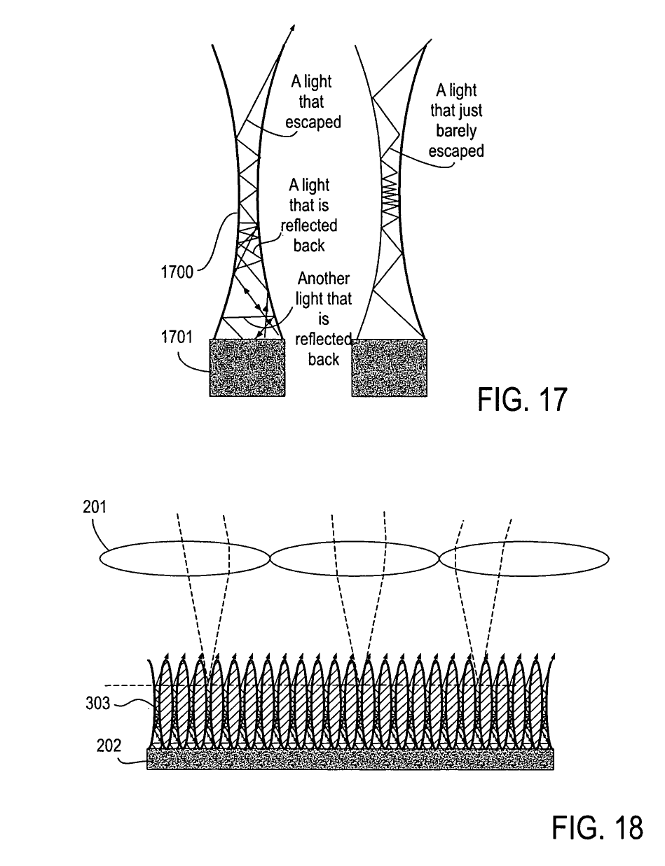

FIG. 17 shows how a micro-mirror reduces the beam divergence. The micro-mirror has the property that only light incident on one opening of the mirror with a small enough incident angles can reach the other opening. Those lights which can't go through the neck of the mirror are reflected by the mirror back out of the incident opening. A significant portion of the back reflected lights are either reflected by the surface of the pixel plane back toward the mirror opening. If the surface is slightly undulating, then the lights reentering the mirror will be randomized and will have roughly the same probability to reach the other opening. The light leaving the mirror likewise will have a small exit angle. This is especially true if the mirror has up-down symmetry. The lights that reenter the display pixel substrate can be further scattered back toward the mirror, or can be reabsorbed and reemitted by the light emitting element. The mirror acts as a filter which admits only small angle incident lights. The combination of small angle filtering and the randomization efficiently converts large angle incident lights into small angle beam.

FIG. 18 is a cross section view that shows how an array of micro-mirrors can be used to steer the beams. The micro-mirror array converts wide-angle beams emanated from the light emitting subpixels into narrow-angle beams and the micro-lens array further reshape the output beams. More importantly, the micro-lens array bends the beams in accordance with the relative horizontal locations of the subpixels with respect to those of the respective microlens. As shown, sub-pixels from different locations within a super-pixel get “tilted” differently. In order for all output beams to tilt at the same direction, the corresponding sub-pixel from each super-pixel must be selected. While the micro-mirror array does not actually reduce the final beam divergence of the display, it greatly improves the light collection efficiency of the microlens array since the light that emerges from the micro-mirror is no longer Lambertian but is already well-collimated, which means there is precious little stray light that goes beyond the aperture of the microlens. Higher light collection efficiency also results in lower crosstalk. Crosstalk arises when light emanating from one pixel gets refracted by one of the adjacent microlens. Crosstalk can reduce the dynamic contrast ratio as well as generate artifact due to pixel mis-registration.

Micro-mirror array is perhaps more useful for non-emissive displays such as LCD displays since for those displays subpixel addressing offers no power saving. When used in LCD displays, each micro-mirror aperture would cover the corresponding pixel with no further subdivision. In this case, the micro-mirror array is entirely responsible for collimating beams emanating from each LCD pixel, and the mechanically steered microlens array takes care of “tilting” the beams.

Subpixel beam steering and collimating method entails some addressing overhead because of the large increase in the number of light emitting elements that constitute the subpixels. Straightforward extension of conventional active matrix addressing technique would require a huge increase in the number of thin film transistors and capacitors as well as a drastic increase in driver complexity and latency. It thus follows that a new addressing scheme is required that can minimize addressing overhead that is needed to drive the large number of subpixels. In accordance with one embodiment of the present invention, there is provided a subpixel addressing method that employs separated subpixel row and column drivers in addition to the conventional X-Y pixel addressing drivers.

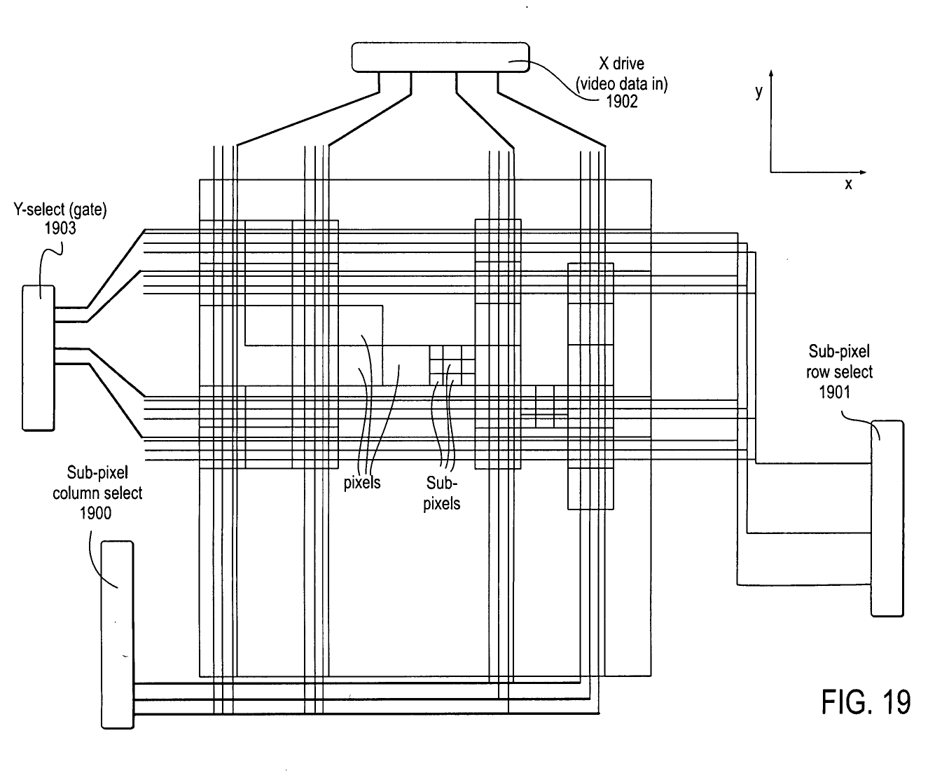

FIG. 19 illustrates an embodiment of the subpixel active matrix addressing using a separate common sub-column and sub-row selection drivers along with conventional row and column drivers. The use of common sub-row driver and common sub-column driver does impose big restrictions on the manner in which the subpixels are addressed. For example, if the 2^{nd} sub-row and 3^{rd} sub-column are selected, only the 2^{nd} sub-row and 3^{rd} sub-column subpixels are addressed. It would indeed be impossible to address the subpixel which is the 2^{nd} sub-row and 3^{rd} sub-column of a pixel located at the 11^{th} row and 39^{th} column, and the subpixel that belongs to the 5^{th} sub-row and 4^{th} sub-column of another pixel since once the sub-row and sub-column are selected, it is the same for all pixels. Further, if 3 subpixels from 3 different sub-rows and 3 different sub-columns are selected, then in addition to the 3 selected subpixels, 6 more subpixels which share the set of selected sub-rows and that of selected sub-columns are also selected. In general, when M sub-rows and N sub-columns are chosen, then a total of N×M subpixels are activated. While such restrictions seem severe, it does in no way hinder the operation of the subpixel beam switching for a single viewer>even for multiple viewers, the restrictions imposed would reduce the power savings but would otherwise not hinder the multi-viewer beam switching.

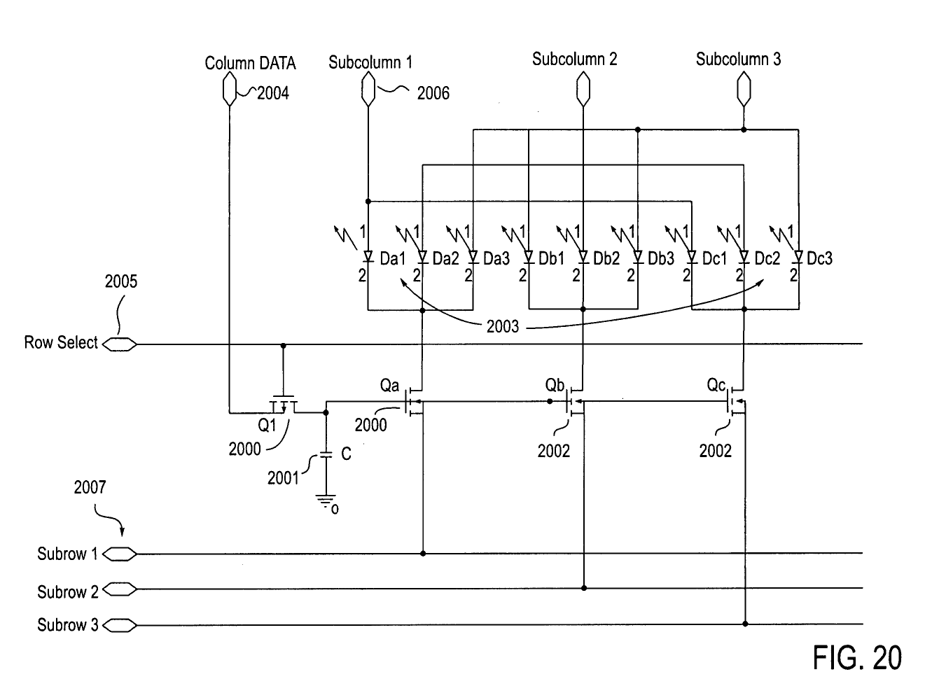

FIG. 20 is a schematic circuit diagram for the subpixel addressing scheme for active-matrix OLED display depicted in FIG. 19. The example shown is for a 3×3 sub-pixel beam steering scheme. Compare to conventional active matrix scheme, which requires 2 transistors (Q1 & Qa) and a capacitor, the sub-pixel scheme requires only two additional transistors (Qb & Qc). Da1, Da2 . . . Dc3 are OLED elements. Video data for the super-pixel is fed from “column DATA” line and is gated by “row” line, and is subsequently stored in the capacitor. The video data is refreshed row by row by turning on the “row” gate voltage and then off in succession. The stored voltage in each capacitor determines the amount of current passing through any one of the “ON” OLED sub-pixel. By allowing only one sub-column and one sub-row to be “ON”, only the corresponding OLED sub-pixel can be lit. Multiple subpixels within a single pixel can also be addressed subject to the restrictions mentioned above. Crosstalk among subpixels sharing the same sub-row and sub-column due to the difference in drain voltages among different pixels is prevented by the reverse voltage blocking of the OLED elements which behave like conventional diodes electrically.

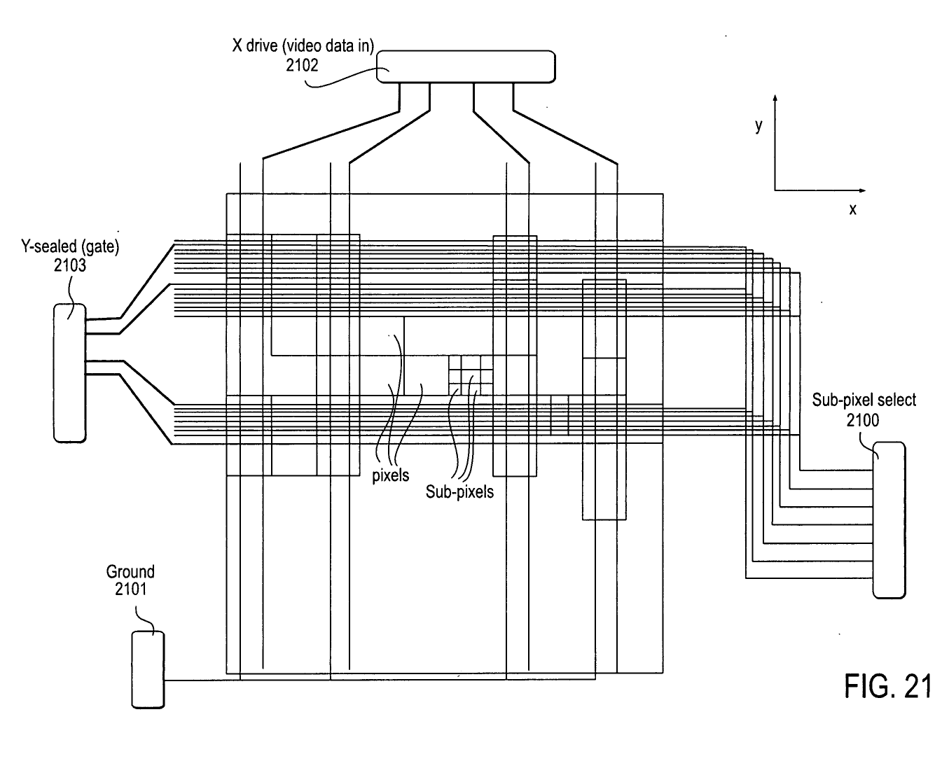

An alternative embodiment of the present invention involves a single separate subpixel driver is illustrated in FIG. 21. In this scheme there are as many global addressing lines interconnecting subpixels of the same index as there are subpixels per pixel. The advantages with this approach are no ghost subpixels are activated that when multiple subpixels are selected and no additional transistors per pixel are needed for active matrix addressing. The downside is that when there are a large number of subpixels per pixel, there may not be enough space for the drastic increase in addressing lines.

FIG. 21 is the schematic circuit diagram for the alternative sub-pixel addressing scheme for active-matrix OLED display. the example is for a 9 sub-pixel beam steering scheme. This scheme uses the same number of active and passive components per pixel as in the conventional active matrix scheme. Video data for the super-pixel is fed from “column DATA” line and is gated by “row” line, and is stored in the capacitor. The video data is refreshed row by row by turning on the “row” gate voltage and then off in succession. The stored voltage in each capacitor determines the amount of current passing through anyone of the “ON” OLED sub-pixel. Only the corresponding OLED sub-pixel can be lit. Crosstalk among subpixels is prevented by the reverse voltage blocking of the OLED elements which behave like conventional diodes electrically.

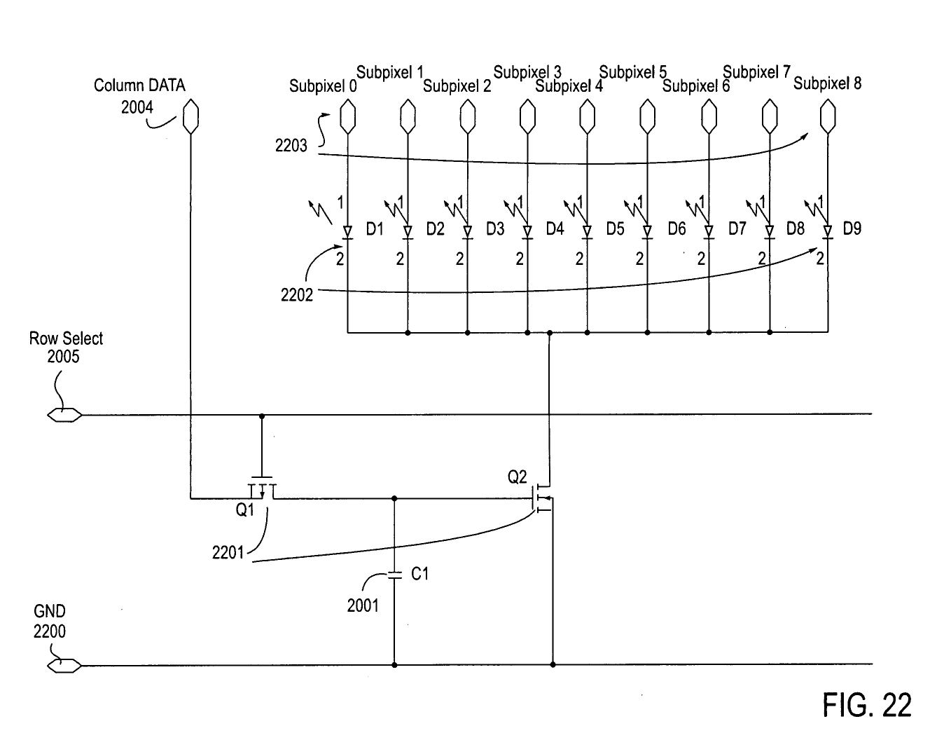

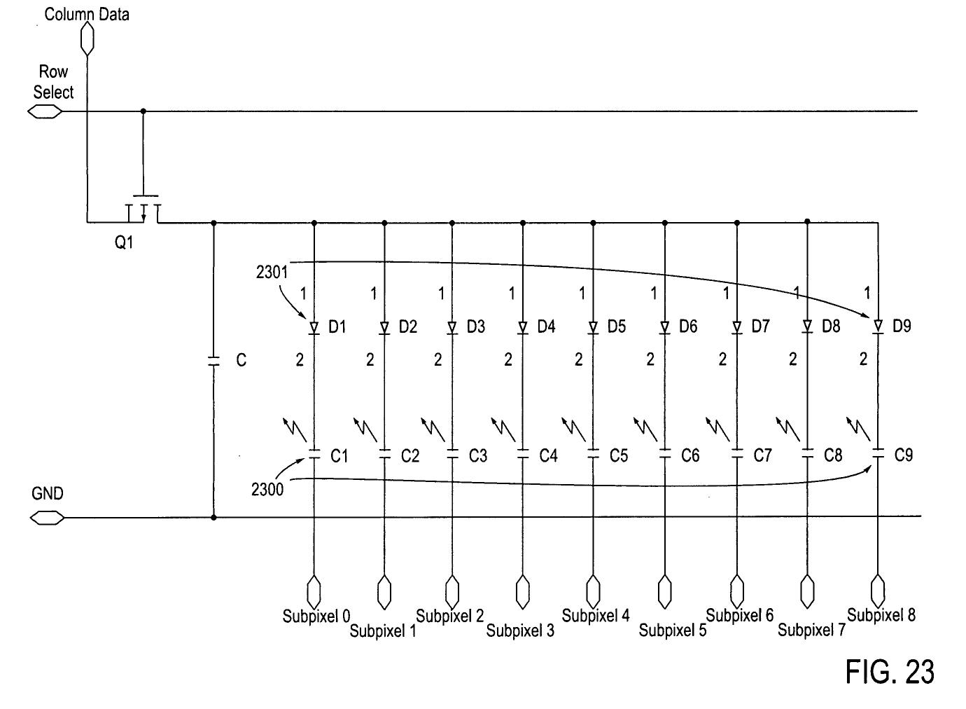

FIG. 22 is the schematic circuit diagram for a voltage based active addressing used by some display technologies such as that of LCD displays. An additional diode for each subpixel is required to prevent cross talk of inactive sub pixels. In this scheme the negative electrodes of the selected subpixels are grounded by the common subpixel select driver. The negative electrodes of the other sub pixels are raised to a high enough voltage to cause the diodes to be reverse-biased. The reverse-bias prevents those sub pixels to be turned on. For LCD displays, though, the subpixel method does not bring about any power saving benefit because the back light has to be on all the time, irrespective of whether the majority of sub pixels are on or not! However, the voltage based addressing scheme may be of use to certain emissive display technologies whose light generating elements are voltage activated, rather than current activated.

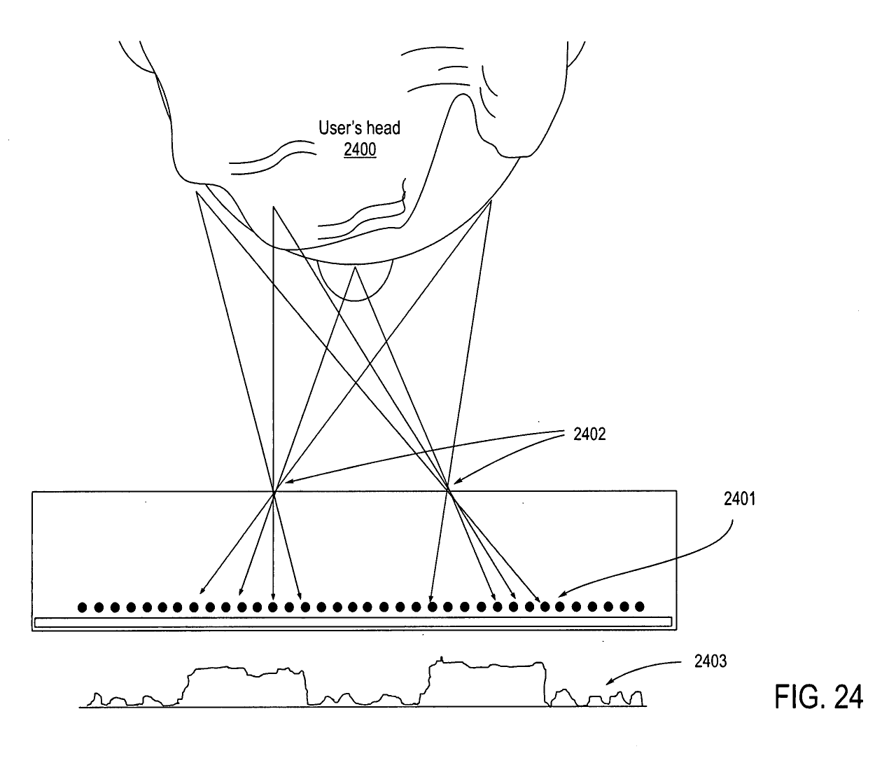

FIG. 24 shows the image formation of the viewer's head by a linear CMOS array with two pinholes. The CMOS array is assumed to be only sensitive to infrared emitted by the body heat of a human being, or an infrared filter can be placed on each of the two pinholes to filter out visible light. The filtering is needed in order to eliminate light emission from inanimate objects from consideration. As shown, through each pinhole a linear image of the head of a viewer is projected unto the array. The two images form two bumps of higher infrared intensity on the CMOS array, against a background of low level stray infrared radiation and infrared images from distant animate objects or other objects of elevated temperature. Additional filtering can be done in firmware to remove objects whose infrared radiation has much higher intensity than one would expect from an animate object. Filtering can also be based on wavelength, thus a light bulb whose temperature is way above than of the human being would have a much shorter wavelength infrared radiation which can be removed easily with an infrared filter with a main window that includes most of the spectrum emitted by a human being but blocks out radiation from a much higher or much lower temperature source.

Background estimation can be performed using an intensity histogram. Intensities that are either too large or too small are excluded from further consideration, as are intensities that do not have neighborhood support. Neighborhood support is defined as the abundance of histogram levels from adjacent intensity bins as well as from adjacent spatial locations. Intensities that do not have neighborhood support are most likely from stray radiation or from distant objects of elevated temperature. After the removal of background intensities, a median filter is used to remove outliers and to “fill in” missing intensities are had been removed prematurely from earlier filtering. The distance between the two “bumps” from the cleaned up images is then used to determine the distance of the head from the screen, as well as the direction of the head relative to the screen.

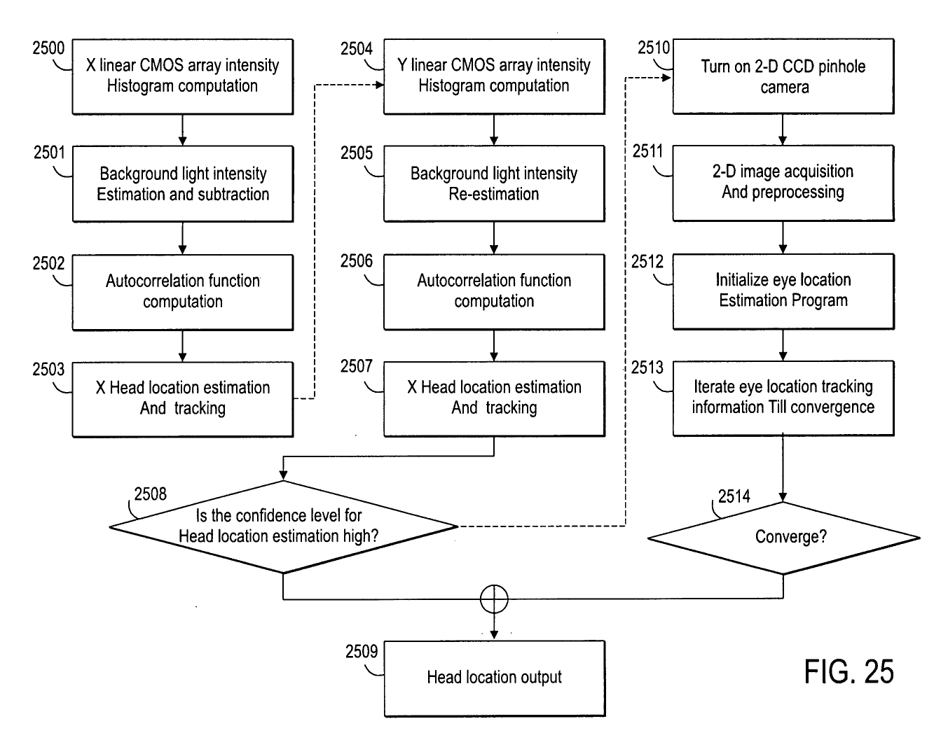

FIG. 25 is a flow chart for the estimation of the head and eye location information. Starting with the image formed on the x-direction linear CMOS array, a histogram is first constructed. It is then used to estimate the intensities of the background radiation which is used to remove the background. To estimate both the distance and direction of the head of the viewer or viewers, an autocorrelation function is computed, which is then used to obtain the head location information in the x-direction. Similarly, the y-direction linear CMOS array is used to form an image in the y direction, a histogram is computed, and background light intensities are estimated and subtracted, followed by the autocorrelation computation. The background intensity calculation can be refined by cross correlate the intensity estimation from the x-CMOS array and that from the y-CMOS array. Finally the head location information in the y direction is obtained. Both the x-direction and y-direction head location information is performed using a Bayesian estimator, which also provides a likelihood score, or confidence level. If the confidence level is sufficiently high, then the head location information is accepted as being correct and is forwarded to a control program. If the head location estimate is not sufficiently accurate or certain, then the two dimensional CCD camera is turned on to produce a 2-D image, which is preprocessed to clean up the image before sending it to the estimation program. The previous head location estimate is then used to initialize the program. The estimation program uses the head location information to produce a rough estimate of the eye locations, and then iterate it until convergence. The converged result is cross correlated with the estimated head tracking information from CMOS arrays and then used by the control program.

While the present disclosure has discussed specific examples for head tracking, beam divergence reduction, mechanical as well as electronic beam steering, it is to be appreciated that the technique in accordance with the present invention can be utilized for or extended to other display types, actuation methods, optical beam collimation techniques, as well as subpixel active matrix addressing schemes. A case in point is to use either an independent mechanically steered CCD camera to pick up high resolution 2-D images of the head of the viewer based on previous estimate of the head location information. This will improve the accuracy of head tracking without the time delay and CPU requirement of a CCD camera which must cover a wide angle and still has enough pixels to cover the head of the viewer. Another example is to use an artificial neural network to fuse the sensory information from the CMOS imaging arrays and CCD camera to form head location information. It is further to be appreciated that the techniques in accordance with the present invention can be equally applied to other device types other than display devices. For example, the subpixel beam steering and active matrix addressing can be advantageously employed to a fast scanning directional camera utilizing the same microlens array and subpixel subdivision. The scanning is done electronically using the subpixel active addressing method; The camera can be used for tracking and acquiring high resolution images of moving target without mechanical actuation.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive. Furthermore, it is not intended that the scope of the invention in any way be limited by the above description, but instead be determined entirely by reference to the claims that follow.

What is claimed is:

1. An apparatus for use in a compact display device having a light emitting source, said apparatus comprising:
a microlens array comprising a plurality of microscopic lenses, which is suspended over the plane of the display device screen and which includes substantially the same number of lenses as there are light emitting picture elements; and
a beam forming means for collimating the lights emitted by the picture elements to a narrow beam; and
a beam steering means for steering the collimated beam to a specific direction in a controllable manner; and
a tracking means for acquiring and tracking the head movements of a plurality of viewers and for converting the tracking data into an estimation of the head and eye locations for said viewers;
Wherein the apparatus is adapted to transform the output from the tracking means into a control signal to control the beam steering means to insure that the beam of light projected from the display device always follows the head movements of said plurality of viewers.

2. The apparatus of claim 1 wherein:
said beam forming means, when combined with the beaming steering means and tracking means, further tends to concentrate light intensity, allowing the total display output power to be reduced without sacrificing image qualify or reducing the effective viewing angle.

3. The apparatus of claim 2 wherein:
said beam forming means comprises further subdividing individual picture elements (pixels) into subpixels and positioning said microlens array in such a way that the pixel plane coincides with the focal plane of said microlens array so that it is adapted to collimate different subpixels within the same pixel to different beam directions.

4. The apparatus of claim 3 wherein:
said beam steering means comprises a subpixel active addressing means adapted to addressing a subset of subpixels within any given pixel in such a way that the number of active elements required for said subpixel active addressing means does not increase in proportion to the increase in the number of addressable elements.

5. The apparatus of claim 4 wherein:
said subpixel active addressing means is a two-level addressing scheme in which every subpixel having the same spatial relationship with respect to the center of the pixel to which it belongs is labeled the same, and pixel level addressing and subpixel label addressing are independently performed.

6. The apparatus of claim 5 wherein:
said subpixel active addressing means comprises ordering the subpixels into sub-rows and sub-columns and common sub-row and sub-column selection drivers which address a subset of subpixel labels having the same sub-rows and sub-columns for all pixels.

7. The apparatus of claim 5 wherein:
said subpixel active addressing means comprises a common subpixel selection driver which addresses a subset of subpixel labels for all pixels.

8. The apparatus of claim 2 wherein:
said beam forming means comprises the removal of all viewing angle enhancement means such as the diffuser, multi-domain vertical alignment, in-plane switching and patterned vertical alignment.

9. The apparatus of claim 8 wherein:
said beam forming means further comprises the replacement of Lambertian backlight with collimated backlight where applicable.

10. The apparatus of claim 8 wherein:
said beam forming means further comprises a micro mirror array mounted on the display pixel plane adapted to reduce the beam divergence of light emitted from individual pixel.

11. The apparatus of claim 10 wherein:
said micro mirror array has substantially the same number of micro mirrors as there are pixels in the display device, and each micro mirror in the array is substantially aligned with the corresponding pixel to maximize optical performance of the micro mirror array.

12. The apparatus of claim 10 wherein:
said micro mirror array has two or more times the number of micro mirrors as there are pixels in the display device.

13. The apparatus of claim 4 wherein:
said beam steering means comprise said beam forming means and said subpixel addressing means.

14. The apparatus of claim 8 wherein:
said beam steering means comprises a mechanical steering means for the microlens array.

15. The apparatus of claim 14 wherein:
said mechanical steering means comprises a plurality of piezoelectric bimorph actuators.

16. The apparatus of claim 15 wherein:
said piezoelectric bimorph actuator comprises an analog-to-digital converter.

17. The apparatus of claim 15 wherein:
said piezoelectric bimorph actuator comprises a pulse coded modulator.

18. The apparatus of claim 1 wherein:
said tracking means comprises a plurality of imaging means.

19. The apparatus of claim 18 wherein:
said imaging means comprises at least one linear imaging array.

20. The apparatus of claim 19 wherein:
said imaging means comprises at least two linear imaging arrays.

21. The apparatus of claim 18 wherein:
said imaging means further comprises a low resolution digital camera.

22. The apparatus of claim 19 wherein:
said linear imaging array comprises a plurality of pinhole lens adapted to form one dimensional images on its focal plane.

23. The apparatus of claim 22 wherein:
said linear imaging array further comprises an optical filter.

24. The apparatus of claim 23 wherein:
said optical filter is an infrared filter adapted to be sensitive to the infrared spectrum emitted by a human body.

25. The apparatus of claim 18 wherein:
said tracking means further comprises a computer firmware or software adapted to analyze and combine image data from said plurality of imaging means.

26. A method for displaying video image in a compact screen, said method comprising:
a) tracking and acquiring the head movements of a plurality of viewers; and
b) converting the tracking data into a real time estimation of the head and eye locations for said viewers; and
c) collimating the lights emitted by the picture elements of said compact screen to a narrow beam or a plurality of beams;
d) steering said collimated beam or beams to a specific direction in a controllable manner; and
e) transforming said viewer's head and eye location data into a control signal to control the beam of light projected from said compact screen such that the light always follows the head movements of said plurality of viewers.

27. The method of claim 26 wherein collimating, tracking, and steering of the lights emitted by said compact display tends to concentrate light intensity, allowing the total display output power to be reduced without sacrificing image qualify or reducing the effective viewing angle.

28. The method of claim 27 wherein collimating lights emitted from said compact display comprises subdividing individual pixels into subpixels so that different subpixels within the same pixel are adapted to being collimated into different beam directions.

29. The method of claim 28 wherein steering said collimated beams further comprises addressing a subset of subpixels within any given pixel in such a way that the number of active elements required does not increase in proportion to the increase in the number of addressable elements.

30. The method of claim 29 wherein addressing said subpixels further comprises a two-level addressing scheme in which every subpixel having the same spatial relationship with respect to the center of the pixel to which it belongs is labeled the same, and pixel level addressing and subpixel label addressing are independently performed.

31. The method of claim 30 wherein addressing said subpixels further comprises ordering the subpixels into sub-rows and sub-columns and providing a common sub-row and a common sub-column selection driver in such a way that together said two drivers address a subset of subpixel labels having the same sub-rows and sub-columns for all pixels.

32. The method of claim 31 wherein addressing subpixels further comprises ordering the subpixels into sub-rows and sub-columns and providing a common sub-row and a common sub-column selection driver in such a way that in combination said two drivers address a subset of subpixel labels having the same sub-rows and sub-columns for all pixels.

33. The method of claim 31 wherein addressing subpixels further comprises a common subpixel selection driver which addresses a subset of subpixel labels for all pixels.

34. The method of claim 27 wherein collimating lights emitted by said compact display further comprises the removal of all viewing angle enhancement means such as the diffuser, multi-domain vertical alignment, in-plane switching and patterned vertical alignment.

35. The method of claim 27 wherein collimating lights emitted from said compact display further comprises reducing the beam divergence of light emitted from individual pixel.

36. The method of claim 35 wherein collimating lights emitted by said compact display further comprises collimating the backlight of a non-emissive compact display for the purpose of reducing the beam divergence of lights emitted by said compact display.

37. The method of claim 35 wherein collimating lights emitted by said compact display further comprises reducing the beam divergence of the light after it is emitted by said non-emissive compact display.

38. The method of claim 37 wherein collimating lights emitted from said compact display further comprises tunneling the light emitted from each pixel through an hourglass shaped micro-mirror which is adapted to reflect lights with a large ingress angle.

39. The method of claim 27 wherein steering said collimated beams further comprises addressing said individual subpixels.

40. The method of claim 27 wherein steering said collimated beams further comprises moving a microlens array whose focal plane coincides with the pixel plane in the transverse directions so as to alter the direction of said collimated beams.

41. The method of claim 41 wherein moving said microlens array comprises applying appropriate voltages to each of a plurality of piezoelectric bimorph actuators.

42. The method of claim 27 wherein tracking and acquiring the head movements of a plurality of viewers comprises periodically taking reduced resolution multi-spectral images of said viewer's heads using a plurality of imaging devices.

43. The method of claim 42 wherein imaging viewer's heads further comprises using an optical filter for each of a subset of imaging device.

44. The method of claim 43 wherein tracking viewer's head movements further comprises analyzing and combining said multi-spectral imaging data in real time to estimate viewer's head locations by using a mathematical algorithm implemented on a microcontroller or a digital signal processing unit.
